(19) United States
(12) Patent Application Publication
(10) Pub. No.: US 2005/0002453 A1
(43) Pub. Date: Jan. 6, 2005

(54) Network-aware adaptive video compression for variable bit rate transmission

(76) Inventors: Leigh Chang, Scarborough (CA); Lei Zhang, Scarborough (CA)

Correspondence Address: Mark B. Eisen;Dimock Stratton LLP, 20 Queen Street West, Suite 3202, Box 102, Toronto, ON, M5H 3R3, CA

(21) Appl. No.: 10/843,663

(22) Filed: May 12, 2004

Related U.S. Application Data
(60) Provisional application No. 60/469,819, filed on May 13, 2003.

(51) Int. Cl. H04N 7/12

(52) U.S. Cl. 375/240.03; 375/240.01

(57) ABSTRACT

In a method of transmitting video data over a packet network, an input video stream is fed to a compressor that generates a compressed output stream. The compressor determines a target bit rate for the output stream based on desired picture quality. A traffic management unit a determines the available bit rate for the compressed data stream based on network condition. The output is adjusted if the target bit rate exceeds the granted bit rate.

### FIELD OF THE INVENTION

The present invention relates to the field of coding and transmitting a digital video signal over a packet network at variable bit rate in order to achieve compression and maintain image quality.

### BACKGROUND OF THE INVENTION

For constant quality real-time video, the bit rate of a MPEG compressed video stream is inherently variable due to variation in picture complexity, amount of motion present and coding method used from frame to frame. When such a variable-bit-rate video stream is transmitted through a packet network, end-to-end delay, packet loss and virtual buffer verifier (VBV) limits, and thus quality of the video, will be adversely affected when the available bandwidth of the network fluctuates in real-time due to other data sources contending for the common network resources and/or changes in link quality.

U.S. Pat. No. 6,535,251, Mar. 18, 2003 entitled “Video encoder and method for adjusting quantization step in real time” describes a method of changing output bit rate of a video encoder in real time according to a computed picture complexity parameter in order to target a pre-determined output bit rate. The method does not take into account network condition and how the target output bit rate can best use the network resources in order to achieve the best possible constant picture quality.

The publication “Constraints on Variable bit rate video for ATM networks”, A. R. Reibman and B. G. Haskell, IEEE Transactions on Circuits and Systems for Video Technology, 254): 361-372 in December 1992, describes a method employing a leaky bucket algorithm wherein the quantization parameter Q is adjusted according to the fill level of a leaky bucket. The method does not take into account the complexity of the scenes being encoded, and thus no attempt is made to maintain a constant level of quality of encoded pictures.

U.S. Pat. No. 5,724,099, Mar. 3, 1998, entitled “Process for controlling the outflow rate of a coder of digital data representative of sequences of images” describes a method of controlling an encoder output rate that takes into account the complexity of the scene while maintaining a no-overflow condition of a leaky bucket. The parameters that define such a leaky bucket are predetermined and remain static during the encoding process and as such cannot reflect the real-time condition of the network in which the encoded output is being transmitted. As a result, the method does not allow the encoder to achieve output bit rate control to adapt to the network resources currently available.

U.S. Pat. No. 5,612,900, Mar. 18, 1997 entitled “VBR MPEG video encoding for ATM networks with dynamic bandwidth renegotiation” describes method wherein a video encoder requests sufficient bandwidth from the ATM network in order to maintain coding quality and limited service delay. The method depends on a signaling protocol between the video encoder and the ATM network. The signaling process is slow in nature. In between signaling calls, the bandwidth available remains static and no real-time adjustment of bit rate is allowed. In addition, in a non-ATM network where above mentioned signaling protocol does not exist, e.g. an IP LAN, the method lacks the necessary feedback mechanism to function properly.

The publication “Statistical multiplexing using MPEG-2 video encoders”, L. Böröczky, A. Y. Ngai, and E. F. Westermann, “Digital Multimedia Technology”, Vol. 43, No. 4, July 1999. IBM describes a rate control algorithm to dynamically distribute the channel bandwidth among multiple MPEG video compressors such that the video quality is approximately equal in all video programs. With this algorithm, the bit rate of each encoder is updated on the basis of the relative complexities of the programs. The algorithm assumes a constant bandwidth being available to the overall multiplexed video output at all time, an assumption that is not always valid.

### SUMMARY OF THE INVENTION

The invention provides a method of predicting compressed video bit rate, allocating target bandwidth and compressing the video according to allocated bandwidth in real-time and thus guaranteeing the best video quality allowed. The method further permits multiple video streams being compressed and/or pre-compressed video streams being recompressed simultaneously and transmitted over the packet network.

According to the present invention there is provided a method of transmitting video data over a packet network, comprising receiving an input video stream; feeding said input video stream to a compressor to generate a compressed output stream at an output bit rate; computing a target bit rate for said output stream based on desired picture quality; negotiating with a traffic management unit a granted bit rate based on network condition; and adjusting said output bit rate if said target bit rate exceed said granted bit rate.

Several compressors can be present for multiple input streams. Also, the input bit stream can be already compressed, in which case it is input to a transcoder for conversion from one compression format to another. However, the transcoder adjusts the output bit rate in the same way as a compressing receiving an incompressed input bit stream.

The method in accordance with the invention can control a compressed video output to track a predetermined constant quality taking into consideration of the available network bandwidth in real-time. As picture complexity, motion activity, scene and compressed picture type change, a constant quality compressed video output will be of variable bit rate in nature. Network bandwidth available to transmit such a compressed video output in a typical local area network will vary depending on network traffic load and link quality conditions.

Without proper bit rate adjustment, there would be periods when the network would not be able to provide the necessary bandwidth for the compressed video stream, and as a result, overflow of packet buffer and overflow/underflow of VBV buffer might occur causing picture quality to degrade significantly. This invention permits the graceful degradation of picture quality from the predetermined constant quality level in the case when insufficient network resources is available or network condition deteriorates such as signal fading in a wireless network. As video quality is a subjective measure and there is not a definition of absolute constant quality, a “constant quality” compressed video sequence in this context is defined to be a stream of compressed video where its quantization factor, frame rate and picture resolution are kept to a set of predetermined constant values.

The video compressors, such as MPEG encoders, and IP packet routing processor that can be integrated in a single system which can either be a printed circuit board assembly or an application specific integrated circuit (ASIC). The video compressors, in collaboration with a video signal processor controller, are individually capable of determining their desired output bit rates for the next video segments by examining the picture complexity of their video inputs.

In one embodiment a traffic management unit in the IP packet routing processor possesses the information of 1) current available bandwidth to each video de-compressor client, 2) current fill-level of the packet buffer, 3) current time delays of the each compressed video packet stream through the system. The video signal processor controller gathers the desired output bit rates and negotiates with the traffic management unit for the allowed output bit rate for each compressed video stream. It balances the granted bit rates from the traffic management unit and adjusts the bit rate of each video compressor accordingly for the next video segment.

In lieu of the video compressors or in addition to the video compressors, one or more compressed video transcoders can be incorporated in the above system. A transcoder takes in a pre-compressed video stream, transcodes or re-compresses it into another compressed video stream of different coding standards/formats and/or of different bit-rate for transmission over the packet network. The video signal processor controller again performs the transcoder output rate adjustment in a similar fashion as described above for video compression.

The invention also provides a system for transmitting video data over a packet network, comprising at least one compression unit for receiving an input video stream, said compression unit having an adjustable compression factor to vary said output bit rate and being capable of computing a target bit rate based on desired picture quality; a traffic management unit for establishing a granted bit rate for said compression unit based on network condition; and a processor for controlling said compression unit to adjust said compression factor to vary said output bit rate if said computed target rate exceeds said granted bit rate.

### BRIEF DESCRIPTION OF THE DRAWING(S)

The invention will now be described in more detail, by way of example only, with reference to the accompanying drawings, in which:

FIG. 1 is a block diagram of a video compression and transmission system in accordance with one embodiment of the invention; and

FIG. 2 is a block diagram of a video compression, transcoding and transmission system in accordance with one embodiment of the invention.

### DETAILED DESCRIPTION OF THE PREFERRED EMBODIMENTS

In the different embodiments, like parts have like reference numerals.

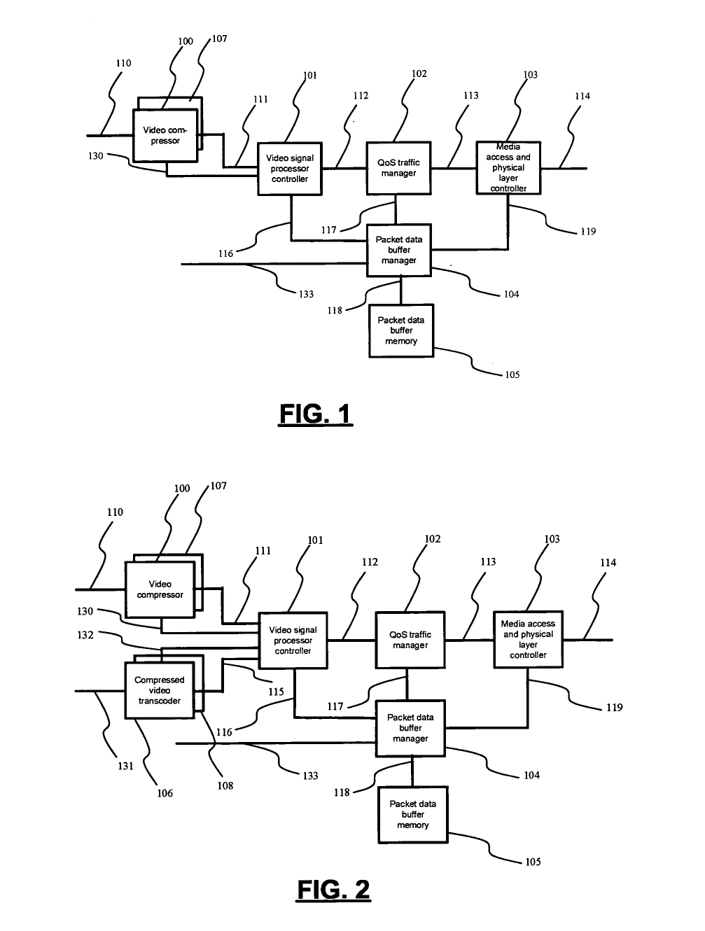

Referring now to FIG. 1, a video signal processor controller 101 analyzes the desired output bit rates for given picture quality levels and actual output bit rates from video compressors 100 and 107, such as MPEG encoders, and granted bit rate, current buffer fullness and system delay condition from a QoS traffic manager 102. Using the results, the video signal processor controller 101 dynamically controls the output bit rate of the video compressors 100 and 107.

A packet data buffer manager 104 stores compressed video packet data and non-video IP packet data in packet data buffer memory 105. The QoS traffic manager 102 schedules the departure of all packets from packet data buffer memory 105 according the QoS requirements for the video and non-video data. A media access and physical layer controller 103 transmits the data packet onto the network and provides media access and physical layer condition feedback to the QoS traffic manager 102.

The video compressor 100 receives uncompressed video digital input 110. Video signal processor controller 101 gathers desired target compressed video bit rate from the compressor 100, and makes the adjustment of the bit rate through a compressor signal processing quality control interface 111. Depending on the available bit rate for a compressor, current VBV buffer fill level, packet buffer fullness and system delay condition and the complexity of the video sequence, the adjustment of output bit rate is done by means that includes, but is not limited to, changing compressor quantization factor, frame resolution and frame rate.

The complexity of a video sequence can be obtained through means of pre-processing a video sequence prior to compressing it. This is useful in the case where longer delay through the system can be tolerated. Alternatively, if shorter delay is desired, the complexity of a new video sequence may be predicted by using statistics accumulated from previous pictures.

The video compressor 100 outputs the compressed video data 130 to the video signal processor controller 101. The video signal processor controller 101 formats the compressed video data 130 into packetized compressed video data 116.

A packet data buffer manager 104 stores and retrieves packetized compressed video data 116 and non-video IP packet data 133 into and from a packet data buffer memory 105 through a packet data memory interface 118.

QoS traffic manager 102 receives compressed video bit rate requests from the video signal processor controller 101, and in turn grants the permitted target bit rate through the compressed video data bandwidth request-grant interface 112. The granted target bit rate is computed from all the compressed video bit rate requests, available bandwidth of each compressor to its de-compressor client, current packet buffer fullness, system delay and QoS requirements for all the video and non-video data.

The QoS traffic manager 102 receives packet storage information from the packet data buffer manager 104, and in turn schedules the packet transmission to the buffer manager 104 through the packet data request-grant interface 117.

The QoS traffic manager 102 receives network condition feedback 113 from the media access and physical layer controller 103. The feedback information includes, but is not limited to, transmission link bit error rate, packet receive ACK/NACK, radio transmission bit rate level.

The packet data buffer manager 104 sends out packet data 119 to the media access and physical layer controller 103, which in turn formats the output packet data 119 and transmits the data output to network interface 114.

Additional video compressors 107 can be incorporated into the system as required to handle additional uncompressed digital video inputs;

Referring now to FIG. 2, video signal processor controller 101 analyzes the desired output bit rates for given picture quality levels and actual output bit rates from the video compressors 100 and 107, as in FIG. 1, and from the transcoders 106 and 108, and granted bit rate, current buffer fullness and system delay condition from a QoS traffic manager 102. Using the results, the video signal processor controller 101 dynamically controls the output bit rate of the video compressors 100 and 107, and the compressed video transcoders 106 and 108. A packet data buffer manager 104 stores compressed video packet data and non-video IP packet data in packet data buffer memory 105. The QoS traffic manager 102 schedules the departure of all packets from packet data buffer memory 205 according the QoS requirements for the video and non-video data. A media access and physical layer controller 103 transmits the data packet onto the network and provides media access and physical layer condition feedback to the QoS traffic manager 102.

The compressors 100 and 107, video signal processor controller 101, QoS traffic manager 102, media access and physical layer controller 103, packet data buffer manager 104 and packet data buffer memory 105 have the same functions and interfaces as described in the above video compression and transmission only system

In addition to the video compressors 100 and 107, or in place of the video compressors 100 and 107, compressed video transcoders are incorporated in the system. A compressed video transcoder 106 receives pre-compressed digital video input 131.

The video signal processor controller 101 gathers desired target compressed video bit rate from the transcoder 106, and controls the adjustment of the bit rate through a transcoder signal processing quality control interface 115.

The transcoder 106 outputs transcoded video data 132 to the video signal processor controller 101.

The video signal processor controller 101 formats the transcoded video data 132 into packetized compressed video data 116 for input to the packet data buffer manager 118.

Additional video transcoders 108 can be incorporated into the system as required to handle additional pre-compressed digital video inputs.

1. A method of transmitting video data over a packet network, comprising:
a) receiving an input video stream;
b) feeding said input video stream to a compressor to generate a compressed output stream at an output bit rate;
c) computing a target bit rate for said output stream based on desired picture quality;
d) negotiating with a traffic management unit a granted bit rate based on network condition; and
e) adjusting said output bit rate if said target bit rate exceeds said granted bit rate.

2. A method as claimed in claim 1, wherein said output bit rate is adjusted by changing one or more of compression quantization factor, frame resolution and frame rate.

3. A method as claimed in claim 2, wherein said network condition includes one or more of virtual buffer verifier fill level, packet buffer fill level, network delay condition.

4. A method as claimed in claim 1, wherein said input video stream is pre-compressed said compressor comprises a transcoder for said compressed output steam in a different format from pre-compressed input stream.

5. A method as claimed in claim 1, wherein said output bit stream is packetized and transmitted over said packet network.

6. A method as claimed in claim 1, comprising receiving multiple parallel input video streams.

7. A method of transmitting video data over a packet network, comprising:
a) receiving an input video stream;
b) feeding said input video stream to a compressor to generate a compressed output stream at an output bit rate;
c) computing a target bit rate for said output stream based on desired picture quality;
d) negotiating with a traffic management unit a granted bit rate based on virtual buffer verifier fill level, packet buffer fill level, and system delay condition of the network, and
e) adjusting a compression characteristic to change said output bit rate if said target bit rate exceeds said granted bit rate.

8. A method as claimed in claim 8, wherein said compression characteristic includes compression one of quantization factor, frame resolution and frame rate.

9. A. system for transmitting video data over a packet network, comprising:
a) at least one compression unit for receiving an input video stream, said compression unit having an adjustable compression factor to vary said output bit rate and being capable of computing a target bit rate based on desired picture quality;
b) a traffic management unit for establishing a granted bit rate for said compression unit based on network condition; and
c) a processor for controlling said compression unit to adjust said compression factor to vary said output bit rate if said computed target rate exceeds said granted bit rate.

10. A system as claimed in claim 1, wherein said processor controls said compressor to adjusts said output bit rate is adjusted by changing one or more of compression quantization factor, frame resolution and frame rate.

11. A system as claimed in claim 10, wherein said network condition includes one or more of virtual buffer verifier fill level, packet buffer fill level, network delay condition.

12. A system as claimed in claim 9, wherein compressor unit comprises a transcoder for receiving an input video stream generated a compressed output stream in a different format from pre-compressed input stream.

13. A system as claimed in claim 9, further comprising a video processor controller for packetizing said output stream.

14. A method as claimed in claim 9, wherein said traffic management unit includes a QoS manager for determining said granted bit rate at least in part on the basis of quality of service requirements.
